(19) United States
(12) Patent Application Publication
(10) Pub. No.: US 2021/0240286 A1
(43) Pub. Date: Aug. 5, 2021

(54) STYLUS PEN, TERMINAL DEVICE SET AND CONTROLLING METHOD THEREOF

(71) Applicant: Samsung Electronics Co., Ltd., Suwon-si (KR)

(72) Inventors: Seongho BYEON, Suwon-si (KR); Pilseob KANG, Suwon-si (KR); Daesung AN, Suwon-si (KR); Dongeon KIM, Suwon-si (KR); Hyunjun KIM, Suwon-si (KR); Chanhee LEE, Suwon-si (KR); Sungho LEE, Suwon-si (KR)

(21) Appl. No.: 17/064,835

(22) Filed: Oct. 7, 2020

(30) Foreign Application Priority Data
Jan. 30, 2020 (KR) 10-2020-0011171

(51) Int. Cl. G06F 3/0354; G06F 3/16; H04R 1/02

(52) U.S. Cl. CPC G06F 3/03545; G06F 2200/1632; H04R 1/028; G06F 3/167

(57) ABSTRACT

A stylus pen and a controlling method thereof are provided. A stylus pen housed in and withdrawn from a terminal device includes a user inputter configured to receive a contact command of a user, a microphone configured to receive a voice command of a user, a communicator configured to transmit the received voice command to the terminal device, and a processor configured to control the user inputter, the microphone, and the communicator, and the processor may, based on the stylus pen being withdrawn from the terminal device, and a first contact command being received through the user inputter, activate the microphone which is in a deactivated state to convert the stylus pen to a main voice input device.

### CROSS-REFERENCE TO RELATED APPLICATION(S)

This application is based on and claims priority under 35 U.S.C. § 119(a) of a Korean patent application number 10-2020-0011171, filed on Jan. 30, 2020, in the Korean Intellectual Property Office, the disclosure of which is incorporated by reference herein in its entirety.

### BACKGROUND

### 1. Field

The disclosure relates to a stylus pen, a terminal device set and a controlling method thereof. More particularly, the disclosure relates to a stylus pen remotely controlling a terminal device, a terminal device set, and a controlling method thereof.

### 2. Description of Related Art

While a terminal device including a touch screen is commercialized, a terminal device including a pen to allow a user to make an input to a terminal device in various ways becomes popular. A user can input various data such as a memo, a drawing, or the like, to a terminal device by using a pen compared to a method of a touch input using only a finger. So far, a pen included in a terminal device merely can perform a conventional pen function in a terminal device.

A performance of a terminal device such as a voice recognition function has been increasingly developed. The voice recognition function of a terminal device is convenient compared to the input method through a touch screen, but there is a problem in that a recognition rate of voice is deteriorated. For example, if the surroundings are noisy, in a case where a user being distant from the terminal device, the terminal device may not properly recognize the user voice command. Since the terminal device may not provide a recognition function for a surrounding environment, there is a problem in that the terminal device outputs a processing result for the recognized command with a predetermined volume.

Therefore, there is a need to improve a recognition rate for voice by using a pen included in a terminal device and outputting a processing result in consideration of a surrounding environment.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a stylus pen, a terminal device set and a controlling method thereof.

Additional aspects will be set forth in part in the description which follows and, in part, will be apparent from the description, or may be learned by practice of the presented embodiments.

In accordance with an aspect of the disclosure, a stylus pen housed in and withdrawn from a terminal device is provided. The stylus pen includes a user inputter configured to receive a contact command of a user, a microphone configured to receive a voice command of a user, a communicator configured to transmit the received voice command to the terminal device, and a processor configured to control the user inputter, the microphone, and the communicator, and the processor may, based on the stylus pen being withdrawn from the terminal device, and a first contact command being received through the user inputter, activate the microphone which is in a deactivated state to convert the stylus pen to a main voice input device.

In accordance with another aspect of the disclosure, a method of controlling a stylus pen housed in and withdrawn from a terminal device is provided. The method includes, after the stylus pen is withdrawn from the terminal device, receiving a first contact command through a user inputter, and converting the stylus pen to a main voice input device by activating a microphone in a deactivated state based on the received first contact command.

In accordance with another aspect of the disclosure, a terminal device set is provided. The terminal device includes a stylus pen housed in and withdrawn from a main terminal device, configured to receive a contact command of a user and transmit the received voice command to the main terminal device, and a main terminal device configured to perform an operation corresponding to the received voice command, and the stylus pen may, based on being withdrawn from the main terminal device and receiving a first contact command from the user, activate a microphone in a deactivated state to convert to a main voice input device, and based on receiving a second contact command, transmit application execution control data for executing an application of the main terminal device to the main terminal device, and the main terminal device may execute an application corresponding to the received application execution control data and output a command set used in the executed application.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a block diagram of a stylus pen according to an embodiment of the disclosure;

FIG. 1B is a block diagram of a stylus pen according to an embodiment of the disclosure;

FIG. 2 is a diagram illustrating a stylus pen according to an embodiment of the disclosure;

FIG. 3 is a diagram illustrating an embodiment of executing a first application in a terminal device using a pen according to an embodiment of the disclosure;

FIG. 4 is a diagram illustrating an embodiment of executing a second application in a terminal device using a pen according to an embodiment of the disclosure;

FIG. 5 is a diagram illustrating an embodiment of executing different applications according to a time of contact command input according to an embodiment of the disclosure;

FIG. 6 is a diagram illustrating an embodiment of executing different applications according to a button status according to an embodiment of the disclosure;

FIG. 7 is a diagram illustrating an embodiment of controlling a first application using a pen according to an embodiment of the disclosure;

FIG. 8 is a diagram illustrating an embodiment of controlling a second application using a pen according to an embodiment of the disclosure; and

FIG. 9 is a flowchart of a method of controlling a stylus pen according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The purpose of the disclosure is to provide a stylus pen, a terminal device set, and a control method thereof, capable of improving a user voice recognition rate and conveniently controlling a terminal device by using a pen included in a terminal device.

Hereinafter, various embodiments will be described in detail with reference to the accompanying drawings. The embodiments described herein may be variously modified. Specific embodiments may be depicted in the drawings and described in detail in the detailed description. However, it is to be understood that the specific embodiments disclosed in the accompanying drawings are only for ease of understanding of various embodiments. Therefore, it is intended that the disclosure not be limited to the particular embodiments disclosed in the accompanying drawings, but on the contrary, the intention is to cover all equivalents or alternatives falling within the spirit and scope of the disclosure.

Although the terms first, second, etc. may be used to describe various components, such elements are not limited by the terms described above. The terms described above are used only to distinguish one element from another.

It is to be understood that the terms such as “comprise,” “comprising,” “including,” and the like, are used herein to designate a presence of a characteristic, number, operation, element, component, or a combination thereof, and do not preclude a presence or a possibility of adding one or more of other characteristics, numbers, operations, elements, components or a combination thereof. When an element is referred to as being “connected ” or “accessed” to another element, it is to be understood that there may be other elements in the middle, although it may be directly connected to or accessed to the other element. In contrast, when an element is referred to as being “directly connected to” or “directly accessed” another element, there are no intervening elements present.

Meanwhile, a “module” or “unit” for a component as used herein performs at least one function or operation. Further, a “module” or “unit” may perform a function or operation by hardware, software, or a combination of hardware and software. In addition, a plurality of “modules” or a plurality of “units” other than “modules” or “units” that are to be performed in particular hardware or performed on at least one processor may be integrated into at least one module. The expression of a singular includes a plurality of representations, unless the context clearly indicates otherwise.

In this specification, only essential components necessary for the description of the disclosure are described and components not related to the essence of the disclosure are not mentioned. Also, only the mentioned components should not be construed to be included in an exclusive sense but should be construed in a non-exclusive sense to include any other component.

In describing the disclosure, when it is determined that a detailed description of related known functions or configurations may make the subject matter of the disclosure unclear, a detailed description thereof will be shortened or omitted. While each embodiment may be implemented or operated independently, each embodiment may be implemented or operated in combination.

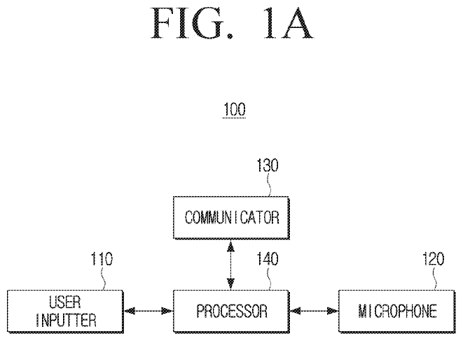

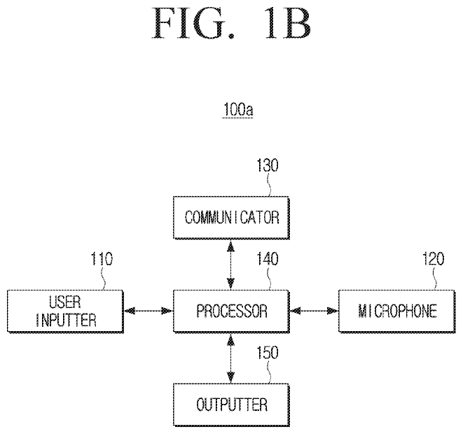

FIG. 1A is a block diagram of a stylus pen according to an embodiment of the disclosure.

Referring to FIG. 1A, a stylus pen 100 includes a user inputter 110, a microphone 120, a communicator 130, and a processor 140. The stylus pen 100 may be housed in and withdrawn from a terminal device. That is, when the stylus pen 100 is not used, the stylus pen 100 may be housed in one region of the terminal device, and when the stylus pen 100 is used, the stylus pen 100 may be withdrawn from the terminal device.

The user inputter 110 receives a contact command. For example, the user inputter 110 may be implemented as a touch button, a push button, or the like. That is, a contact command may refer to a command received by a user's touch or a press. The user inputter 110 may include a plurality of buttons, and at least some of the buttons may be disposed on a side portion of the stylus pen 100. Therefore, based on the stylus pen 100 being housed in the terminal device, the user inputter 110 disposed on the side portion is not exposed to the outside and thus, the user can prevent an input error of the stylus pen 100. Based on the stylus pen 100 being withdrawn from the terminal device, the user inputter 110 disposed on the side portion may also be exposed to the outside. Accordingly, the stylus pen 100 may receive a contact command from a user through the user inputter 110, and may perform an operation corresponding to the input contact command.

The user inputter 110 may receive different contact commands, and the stylus pen 100 may perform an operation corresponding to the received contact command. A specific contact command received by the stylus pen 100 and a corresponding operation of the stylus pen 100 will be described below.

The microphone 120 may receive a voice command of a user. The communicator 130 can transmit the received user voice command to a terminal device. The communicator 130 may include a local area communication module. For example, the local area communication module may communicate with a local terminal device using techniques such as Bluetooth, infrared communication, radio frequency identification device (RFID), Zigbee, wireless fidelity (Wi-Fi), and the like. The terminal device can perform an operation such as application execution, control, termination, or the like, according to a user voice command received from the stylus pen 100.

The processor 140 may perform an operation corresponding to the contact command received from the user inputter 110. For example, when the user inputter 110 receives a microphone 120 activation command from a user, the processor 140 may activate the microphone 120 in an inactivated state of the stylus pen 100 and convert the stylus pen 100 into a main voice input device. The processor 140 can control the communicator 130 to transmit information that the stylus pen 100 has been converted to a main voice input device to the terminal device. When an application execution command is received through the user inputter 110, the processor 140 can control the communicator 130 to transmit the application execution control command to the terminal device. The terminal device can execute the application according to the application execution control command received from the stylus pen 100.

When the application is executing on the terminal device, the stylus pen 100 can receive a voice command from a user and control the application of the terminal device. For example, the microphone 120 may receive a voice command from a user. The processor 140 may control the communicator 130 to transmit an app control command corresponding to the received user voice command to the terminal device. The terminal device may perform an app control operation corresponding to the app control command received from the stylus pen 100.

The stylus pen may further include an outputter 150.

FIG. 1B is a diagram illustrating a stylus pen according to an embodiment of the disclosure.

Referring to FIG. 1B, a stylus pen 100a may include the user inputter 110, the microphone 120, the communicator 130, the processor 140, and the outputter 150. Since the user inputter 110, the microphone 120, the communicator 130, and the processor 140 are the same as those described above, a detailed description thereof will be omitted.

The outputter 150 may output status information, contact command information, voice command information, or the like, of the stylus pen. For example, the status information of the stylus pen may include information on whether the microphone is activated, whether the voice command is recognized, whether the terminal device is connected or not, the type of the inputted command, or the like. The contact command information may include information about a contact command input by a user, and the voice command information may include information on a voice command input by the user.

The outputter 150 may be implemented as a speaker, a light emitting diode (LED), a display, a vibration motor, or the like.

When the outputter 150 is implemented as a speaker, the outputter 150 may output the output information as a voice or sound (or melody). For example, when the microphone is activated, the outputter 150 can output a preset first sound, and when a contact command is input, the outputter 150 can output a preset second sound. When the outputter 150 is implemented as an LED, the outputter 150 can output the output information as a predetermined color, a preset number of output LEDs, and a predetermined output pattern. When the outputter 150 is implemented as a display, the outputter 150 may display output information on a display. When the outputter 150 is implemented as a vibration motor, the outputter 150 may output the output information as a preset vibration intensity, a preset vibration pattern, or the like. The outputter 150 may be implemented with one of a speaker, an LED, a display, and a vibration motor, or a plurality of types. In addition, the outputter 150 may include at least one LED.

The terminal device 10 may include a touch screen for receiving a user command by a touch, a touch screen for outputting an image, a microphone for receiving a voice command of a user, a speaker for outputting audio data, a communicator for performing communication with the stylus pen, and a processor for controlling each configuration of the terminal device, or the like.

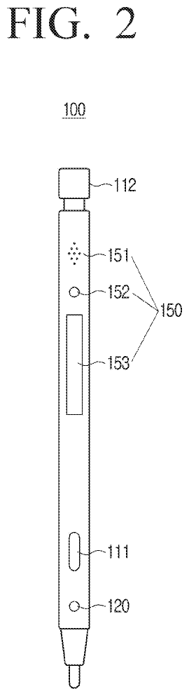

FIG. 2 is a diagram illustrating a stylus pen according to an embodiment of the disclosure.

Referring to FIG. 2, a structure of the stylus pen 100 according to an embodiment is illustrated. As illustrated above, the stylus pen 100 may include a user inputter (such as a first button 111 and a second button 112), the microphone 120, and the outputter 150, and the outputter 150 may include a speaker 151, an LED 152, and a display 153.

The user inputters (e.g., first button 111 and second button 112) may include a plurality of buttons, the first button 111 may be disposed on a side portion of the stylus pen 100, and the second button 112 may be disposed at one end of the stylus pen 100. When the stylus pen 100 is housed in the terminal device, the first button 111 may be located within the terminal device. The second button 112 may operate in a toggled manner. Accordingly, when the second button 112 is pressed once, a portion to which the second button 112 and the main body of the stylus pen 100 are connected may be inserted into the stylus pen 100, and when the second button 112 is pressed once again, a connected portion may be withdrawn out of the main body of the stylus pen 100. FIG. 2 illustrates the stylus pen 100 including the first button 111, but the first button 111 may be implemented as a touch pad. The microphone 120 and the outputter 150 may also be disposed on a side portion of the stylus pen 100. Although the speaker 151, the LED 152, and the display 153 are illustrated in FIG. 2, the outputter 150 may include any one or a plurality of the speaker 151, the LED 152, and the display 153. In some cases, the stylus pen 100 may not include the outputter 150. The outputter 150 may also include a vibration motor, which may be disposed within the stylus pen 100.

The configuration and structure of the stylus pen 100 have been described. An operation of the stylus pen 100 will be described below.

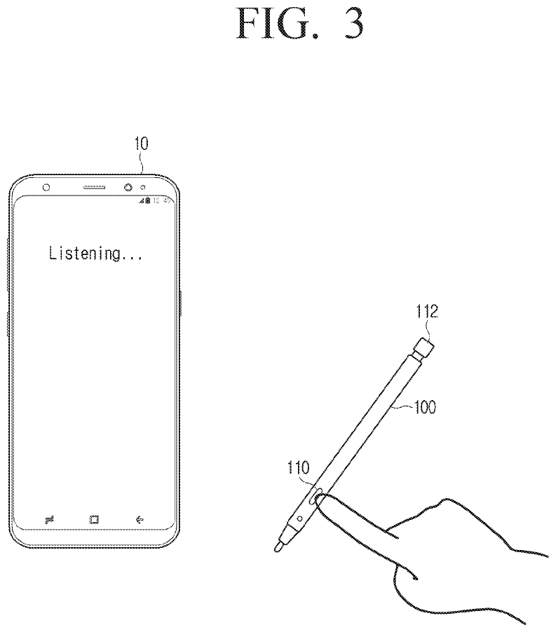

FIG. 3 is a diagram illustrating an embodiment of executing a first application in a terminal device using a pen according to an embodiment of the disclosure.

FIG. 3 illustrates the terminal device 10 and the stylus pen 100. The stylus pen 100 may be positioned in a state of being inserted in the terminal device 10. A user may withdraw the stylus pen 100 from the terminal device 10 to use the stylus pen 100. The user can input a first contact command through a user inputter of the stylus pen 100. In one embodiment, the first contact command may be a type in which the user inputter is pressed three consecutive times. The first contact command described above is an embodiment, and the first contact command may be set in a variety of ways. When the stylus pen 100 receives a first contact command from a user, the stylus pen 100 may activate a microphone in a deactivated state to convert the stylus pen to a main voice input device.

When the stylus pen 100 is converted to a main voice input device, the stylus pen 100 can transmit information related to conversion of the main voice input device to the terminal device 10. The terminal device 10 can recognize that the stylus pen 100 has been converted to the main voice input device and may deactivate the microphone of the terminal device 10.

The stylus pen 100 may receive a second contact command from a user. When the stylus pen 100 receives the second contact command, the application execution control data can be transmitted to the terminal device 10. For example, the second contact command may be in a manner of pressing for at least a predetermined time. The terminal device 10 may receive app execution control data and execute a corresponding app. The app being executed on the terminal device 10 can be determined in a variety of ways.

Referring to FIG. 3, the stylus pen 100 may transmit app execution control data to the terminal device 10 in response to the second contact command, and the terminal device 10 receiving the application execution control data can execute the recently executed app. Alternatively, when the terminal device 10 is in a standby state, the voice assistant service application may be executed, and when the terminal device 10 is in a state in which the specific app is executed, the terminal device 10 can maintain a standby state capable of receiving a control command for the executing application. Alternatively, the stylus pen 100 may transmit the first app execution control data or the second app execution control data according to the input time of the second contact command. The terminal device 10 can execute the first app or the second app according to the first or second application execution control data. For example, the first app may be a voice assistant service app and the second app may be a camera app. Alternatively, the stylus pen 100 may transmit the first application execution control data or the second app execution control data according to the state of the second button.

Referring to FIG. 3, an example in which a first app (e.g., a voice assistant service app) is executed at the terminal device 10 is illustrated. After the stylus pen 100 receives the first contact command and is converted into the main voice input device, the stylus pen 100 may receive the second contact command and transmit the application execution control data to the terminal device 10. The terminal device 10 may execute the first application based on the received application execution control data. As described above, the terminal device 10 may execute the first application that was most recently executed. Alternatively, when the terminal device 10 receives the application execution control data in the standby state, the terminal device 10 can execute the first application. Alternatively, the stylus pen 100 may receive the second application command over a predetermined period of time and transmit the first application execution control data. The terminal device 10 may execute the first application based on the received first app execution control data. Alternatively, the stylus pen 100 may transmit the first or second application execution control data to the terminal device 10 according to the state of a portion in which the second button 112 and main body of the stylus pen 100 are connected. In one embodiment, while a portion in which the second button 112 and the main body of the stylus pen 100 are connected being withdrawn out of the main body of the stylus pen 100, if the stylus pen 100 receives the second contact command, the first application execution control data can be transmitted. The terminal device 10 may execute the first application based on the received first application execution control data.

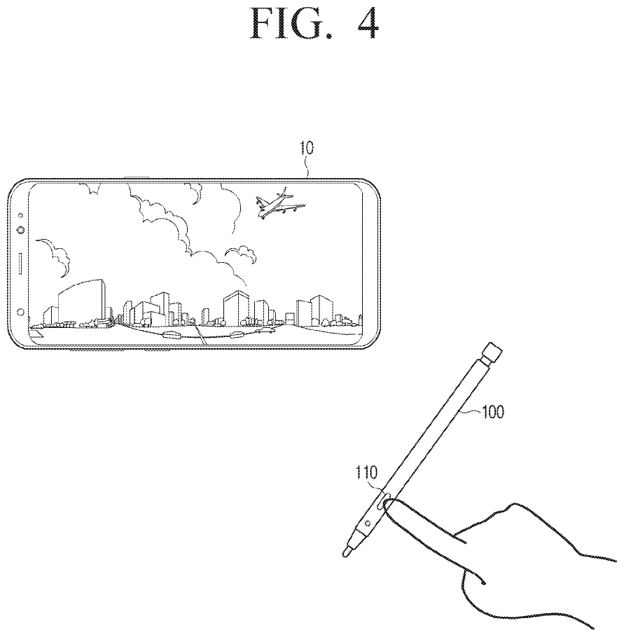

FIG. 4 is a diagram illustrating an embodiment of executing a second application in a terminal device using a pen according to an embodiment of the disclosure.

Referring to FIG. 4, an example of the terminal device 10 executing a second application (e.g., a camera application) is illustrated. As described above, the stylus pen 100 may receive a first contact command from the user and may convert to a main voice input device. The stylus pen 100 may receive a second contact command for executing the application. When the stylus pen 100 receives the second contact command, the application execution control data can be transmitted to the terminal device 10.

The terminal device 10 may execute a second application (e.g., a camera application) based on the received application execution control data. As described above, the terminal device 10 may execute a second application that was most recently executed. Alternatively, in a state where a specific application is executed, the terminal device 10 may maintain a state of receiving a control command for the application being executed. Alternatively, the stylus pen 100 may receive the second contact command for greater than or equal to a predetermined period of time and transmit the second application execution control data. The terminal device 10 can execute the second application based on the received second application execution control data. Alternatively, when the second contact command is input, the stylus pen 100 may transmit the first or second application execution control data to the terminal device 10 according to the state of the second button 112.

When the microphone of the stylus pen 100 is activated, and the application is executed in the terminal device 10, the stylus pen 100 may control the application which is being executed in the terminal device 10 based on the input user voice command.

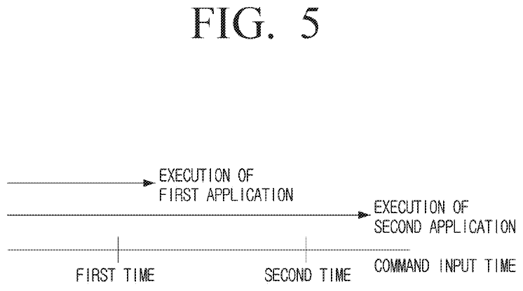

FIG. 5 is a diagram illustrating an embodiment of executing different applications according to a time of contact command input according to an embodiment of the disclosure.

Referring to FIG. 5, as described above, the stylus pen can transmit control data for executing the first application or the second application to the terminal device based on the input time of the second contact command through the user inputter. In one embodiment, the second contact command may be a command of pressing the user inputter for a predetermined time or more. The first and second thresholds may be stored in the stylus pen 100 in association with the input of the second contact command. That is, when the input time of the second contact command of the stylus pen 100 is greater than or equal to the first threshold value (or the first time) and less than the second threshold value (or the second time), the stylus pen 100 can generate control data for executing the first application and transmit the control data to the terminal device. When the input time of the second contact command of the stylus pen 100 is greater than or equal to the second threshold value (or the second time), the stylus pen 100 can generate control data for executing the second application and transmit the control data to the terminal device. The terminal device can execute an application corresponding to the application execution control data transmitted from the stylus pen 100. The stylus pen 100 may transmit the first or second application execution control data to the terminal device in a different manner.

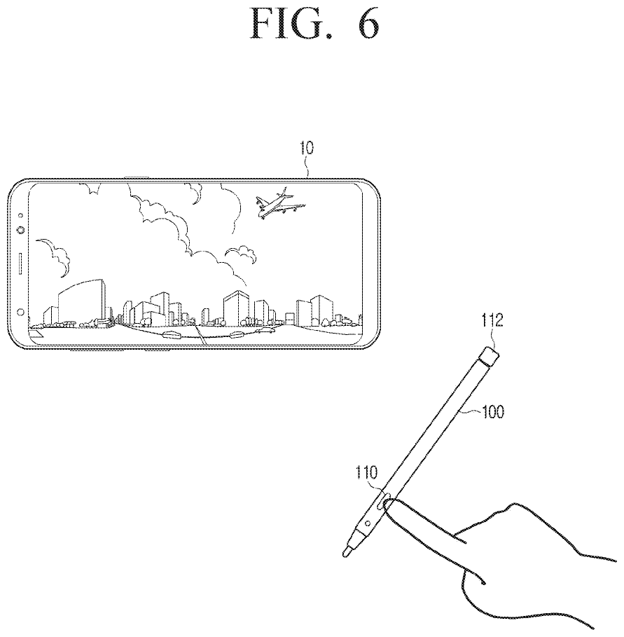

FIG. 6 is a diagram illustrating an embodiment of executing different applications according to a button status according to an embodiment of the disclosure.

Referring to FIG. 6, the stylus pen 100 transmits second application execution control data to the terminal device 10, and the terminal device 10 executes a second application (e.g., a camera application). As described above, the stylus pen 100 can transmit the first or second application execution control data to the terminal device 10 according to the state of the second button 112.

Referring to FIG. 6, when the stylus pen 100 receives the second contact command while a portion of the second button 112 is inserted into the main body of the stylus pen 100, the second application execution control data can be transmitted to the terminal device 10. The terminal device 10 can execute the second application based on the received second application execution control data.

When the stylus pen 100 receives the second contact command while a portion of the second button 112 is withdrawn out of the main body of the stylus pen 100, the first application execution control data can be transmitted to the terminal device 10. The terminal device 10 may execute the first application based on the received first application execution control data. The second button 112 may operate in a toggle manner. Accordingly, when the second button 112 is pressed once, a portion of the second button 112 may be inserted into the main body of the stylus pen 100, and when the second button 112 is pressed once again, a portion of the second button 112 can be withdrawn out of the main body of the stylus pen 100. When the second contact command is input, the stylus pen 100 can transmit the first or second application execution control data to the terminal device 10 based on the state of the second button 112.

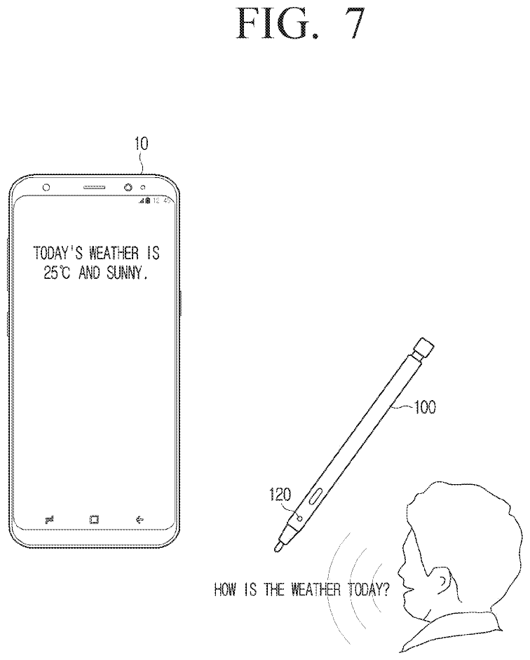

FIG. 7 is a diagram illustrating an embodiment of controlling a first application using a pen according to an embodiment of the disclosure.

Referring to FIG. 7, an embodiment of controlling a terminal device with the stylus pen 100 when a first application is executed in a terminal device is illustrated. The microphone 120 of the stylus pen 100 may receive a voice command from a user. The stylus pen 100 can transmit the input voice command to the terminal device 10. That is, the stylus pen 100 can transmit the first application control data corresponding to the input voice command to the terminal device 10. The terminal device 10 may perform a control operation based on the received first application control data. In one embodiment, if the first application is a voice assistant service application and the user has asked today's weather, the terminal device 10 may output information about the today's weather.

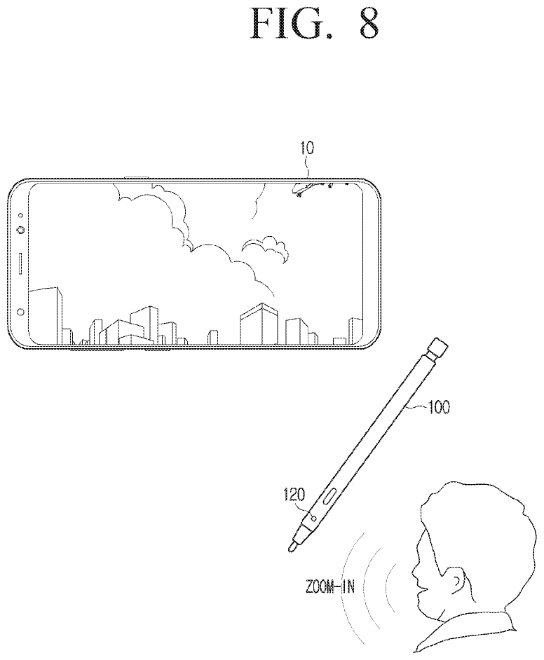

FIG. 8 is a diagram illustrating an embodiment of controlling a second application using a pen according to an embodiment of the disclosure.

Referring to FIG. 8, an embodiment of controlling a terminal device with the stylus pen 100 when a second application is executed in the terminal device is illustrated. The microphone 120 of the stylus pen 100 may receive a voice command from a user and transmit the corresponding second application control data to the terminal device 10. The terminal device 10 may perform a control operation based on the received second application control data. In one embodiment, if the second application is a camera application and the user gives a command of a zoom-in, the terminal device 10 may perform a zoom-in function of the camera.

The terminal device 10 may output a set of commands usable in an application being executed. For example, if the application being executed is a voice assistant service application, the terminal device 10 may output a set of executable voice commands or examples. The terminal device 10 may set a user-defined voice command set according to a user's selection from among a set of executable voice commands. For example, the set of voice command that can be performed by the camera application may include commands such as brightness adjustment, sharpness adjustment, input and output voice magnitude adjustment, zoom-in/out, capturing mode, video mode, broadcast mode, mode selection and termination, continuous capturing, resolution adjustment, or the like.

In one embodiment, when the application that is executed by the terminal device 10 is a camera application and is set to a personal broadcasting mode or a selfie mode, the terminal device 10 can be spaced apart from the user by a predetermined distance. When the voice is input using the microphone of the terminal device 10, the user has to utter loudly or include a lot of ambient noises due to the distance between the user and the microphone of the terminal device 10. However, the stylus pen 100 is separable from the terminal device 10 and can be located close to the user, thereby reducing the distance between the point of utterance and the voice recognition portion. Therefore, when the stylus pen 100 is set as the main voice input device, a higher signal-to-noise ratio (SNR) voice data can be collected. Accordingly, content with high quality can be produced.

The stylus pen 100 can terminate an application being executed on the terminal device or deactivate the activated microphone based on a contact command of the user. For example, when the second contact command for transmitting the application execution control data from the stylus pen 100 to the terminal device 10 is input again to the stylus pen 100, the stylus pen 100 can transmit, to the terminal device 10, the application termination control data to terminate the application being executed in the terminal device 10. The terminal device 10 receiving the application termination control data can terminate the application being executed. In addition, when the first contact command for activating the microphone of the stylus pen 100 is input to the stylus pen 100 again, the stylus pen 100 can deactivate the microphone. At this time, the stylus pen 100 can transmit information that the microphone has been deactivated to the terminal device 10.

The terminal device 10 communicates with the stylus pen 100. Accordingly, the terminal device 10 can calculate a distance with the stylus pen 100 based on a data transmission time, a request and a response time, or the like. Alternatively, when the user utters, the distance between the terminal device 10 and the stylus pen 100 may be calculated based on a time difference at which voice is input through the microphone of the terminal device 10 and a time difference at which voice is input through the microphone of the stylus pen 100. When audio data is output through the speaker of the terminal device 10, the terminal device 10 can control the intensity of the output based on the calculated distance of the stylus pen 100. For example, the terminal device 10 may output an output indicative of a set of executable commands in the application. If the terminal device 10 identifies that the distance with the stylus pen 100 is too far, the size of the displayed command set or the size of the font may be output to be relatively large. If the terminal device 10 identifies that the distance with the stylus pen 100 is close, the size of the displayed command set or the size of the font may be output to be relatively small. Alternatively, the terminal device 10 may output a sound (audio) including various voices to the user. If the terminal device 10 identifies that the distance with the stylus pen 100 is too far, the volume of the output sound may be output to be relatively large. If the terminal device 10 identifies that the distance with the stylus pen 100 is close, the volume of the output sound may be output to be relatively small.

Various embodiments of the stylus pen 100 have been described. A method of controlling the stylus pen will be described below.

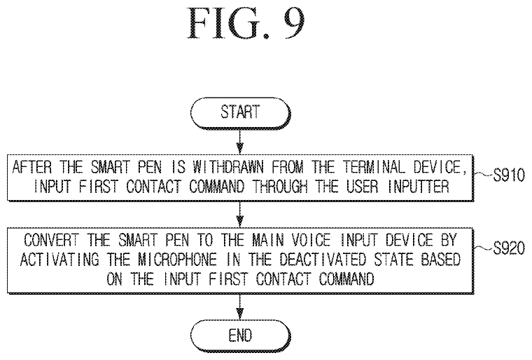

FIG. 9 is a flowchart of a method of controlling a stylus pen according to an embodiment of the disclosure.

Referring to FIG. 9, after the stylus pen is drawn from the terminal device, the first contact command is received through the user inputter in operation S910. In one embodiment, the first contact command is a command received through a physical inputter, such as a button or a touch pad, which may be three consecutive presses or touches.

The stylus pen may convert the stylus pen into a main voice input device by activating a microphone in a deactivated state based on the input first contact command in operation S920. After the microphone is activated, if the stylus pen receives the first contact command again, the microphone can be deactivated.

After the microphone is activated, the stylus pen may receive a second contact command through a user inputter, and transmit application execution control data for executing an application of the terminal device based on the input second contact command. In one embodiment, when the input time of the second contact command is greater than or equal to the first threshold time and less than the second threshold time, the stylus pen may transmit the first application execution control data, and if the input time of the second contact command is greater than or equal to the second threshold time, the stylus pen may transmit the second application execution control data.

The user inputter of the stylus pen may include a first button and a second button. As another embodiment, the stylus pen may transmit the first or second application execution control data depending on whether a portion of the second button has been drawn to the outside. The stylus pen may receive a voice command through a microphone and transmit control data for an application being executed on the terminal device to the terminal device based on the input voice command. The terminal device can control the operation of the application based on the received control data.

While the app is being executed, when the stylus pen receives the second contact command again, the stylus pen may transmit the application termination control data to terminate the application which is being executed to the terminal device.

When a voice command of a user is input using a stylus pen, voice may be input at a location closer to the terminal device and thus, content with a clean sound can be generated. The stylus pen is located in close proximity to the user and if it is necessary to send voice in a quiet place, the stylus pen is advantageous when transmitting sensitive information such as a password.

The method for controlling the stylus pen according to the various embodiments described above may be provided as a computer program product. The computer program product may include a software (S/W) program itself or a non-transitory computer readable medium in which the S/W program is stored.

A non-transitory readable medium refers to a medium that stores data semi-permanently, rather than a medium that stores data for a short moment, such as a register, cache, memory, etc., and refers to a medium readable by a device. Specifically, the various applications or programs described above may be stored and provided in a non-transitory, readable medium, such as a compact disc (CD), a digital versatile disc (DVD), a hard disc, a Blu-ray disc, a universal serial bus (USB), a memory card, a read only memory (ROM), or the like.

While the disclosure has been described with reference to the accompanying drawings, it is to be understood that the scope of the disclosure is defined by the claims described hereinafter and should not be construed as being limited to the above-described embodiments and/or drawings. It is to be clearly understood that improvements, changes, and modifications that are obvious to those skilled in the art are also within the scope of the disclosure as defined in the claims.

According to various embodiments, a stylus pen, a terminal device set, and a control method thereof are capable of receiving a user's voice at a location closer than a terminal device.

The stylus pen, the terminal device set, and the control method thereof can receive a voice input with a small sound.

The stylus pen, the terminal device set, and the control method thereof can conveniently control a remote terminal device by using a pen.

The effects of the disclosure are not limited to the effects mentioned above, and other effects not mentioned herein may be apparent to a person skilled in the art from the above description.

What is claimed is:

1. A stylus pen housed in and withdrawn from a terminal device, comprising:
a user inputter configured to receive a contact command of a user;
a microphone configured to receive a voice command of a user;
a communicator configured to transmit the received voice command to the terminal device; and
a processor configured to control the user inputter, the microphone, and the communicator,
wherein the processor is further configured to:
based on the stylus pen being withdrawn from the terminal device, and a first contact command being received through the user inputter, activate the microphone which is in a deactivated state to convert the stylus pen to a main voice input device.

2. The stylus pen of claim 1, wherein the processor is further configured to, based on receiving a second contact command through the user inputter, control the communicator to transmit application execution control data for executing an application of the terminal device to the terminal device.

3. The stylus pen of claim 2,
wherein the second contact command is a command that is input for greater than or equal to a predetermined first time, and
wherein the processor is further configured to:
based on the second contact command being input for greater than or equal to a predetermined first time, control the communicator to transmit first application execution control data for executing a first application of the terminal device to the terminal device, and
based on the second contact command being input for greater than or equal to a second time that is longer than the predetermined first time, control the communicator to transmit the second application execution control data for executing a second application of the terminal device to the terminal device.

4. The stylus pen of claim 2, wherein the user inputter comprises:
a first button receiving a first contact command; and
a second button configured to be housed in or withdrawn from the stylus pen,
wherein the processor is further configured to:
based on the second button being inserted in the stylus pen, control the communicator to transmit, to the terminal device, first application execution control data for executing a first application of the terminal device, and
based on the second button being withdrawn to an outside of the stylus pen, control the communicator to transmit, to the terminal device, second application execution control data for executing a second application of the terminal device.

5. The stylus pen of claim 2, wherein the processor is further configured to:
based on an application being executed in the terminal device being a voice assistant service application, control the communication to transmit, to the terminal device, control data relative to the voice assistant application based on the input voice command of a user, and
based on the application being executed in the terminal device being a camera application, control the communicator to transmit, to the terminal device, control data relative to the camera application based on the input voice command of the user.

6. The stylus pen of claim 2, wherein the processor is further configured to, based on receiving the second contact command again through the user inputter, control the communicator to transmit, to the terminal device, application termination data for terminating the application of the terminal device.

7. The stylus pen of claim 1, further comprising:
an outputter configured to output at least one of status information, contact command information, or the voice command information of the stylus pen.

8. The stylus pen of claim 7, wherein the outputter comprises at least one of a speaker, a light emitting diode (LED), a display, or a motor.

9. The stylus pen of claim 1, wherein the processor is further configured to, based on receiving the first contact command again through the user inputter, deactivate the activated microphone.

10. A method of controlling a stylus pen housed in and withdrawn from a terminal device, the method comprising:
after the stylus pen is withdrawn from the terminal device, receiving a first contact command through a user inputter; and
converting the stylus pen to a main voice input device by activating a microphone in a deactivated state based on the received first contact command.

11. The method of claim 10, further comprising:
receiving a second contact command through the user inputter; and
transmitting, to the terminal device, application execution control data for executing an application of the terminal device based on the input second contact command.

12. The method of claim 11,
wherein the second contact command is a command that is input for greater than or equal to a predetermined first time, and
wherein the transmitting the application execution control data to the terminal device comprises:
transmitting first application execution control data for executing a first application of the terminal device to the terminal device, and
based on the second contact command being input for greater than or equal to a second time that is longer than the predetermined first time, transmitting the second application execution control data for executing a second application of the terminal device to the terminal device.

13. The method of claim 11, wherein the transmitting the application execution control data to the terminal device comprises:
based on the second button included in the user inputter being inserted in the stylus pen, transmitting, to the terminal device, first application execution control data for executing a first application of the terminal device, and
based on the second button being withdrawn to an outside of the stylus pen, transmitting, to the terminal device, second application execution control data for executing a second application of the terminal device.

14. The method of claim 11, further comprising:
transmitting application control data for controlling an application of the terminal device to the terminal device,
wherein the transmitting the application control data to the terminal device comprises:
based on the application being executed in the terminal device being a voice assistant service application, transmitting, to the terminal device, control data relative to the voice assistant application based on the input voice command of a user, and
based on the application being executed in the terminal device being a camera application, transmitting, to the terminal device, control data relative to the camera application based on the received voice command of the user.

15. The method of claim 11, further comprising:
receiving the second contact command again through the user inputter; and
transmitting, to the terminal device, application termination data for terminating the application of the terminal device based on the second contact command input again.

16. The method of claim 10, further comprising:
outputting at least one of status information, contact command information, or the voice command information of the stylus pen.

17. The method of claim 10, further comprising:
receiving the first contact command again through the user inputter; and
deactivating the activated microphone based on the first contact command input again.

18. A terminal device set comprising:
a stylus pen housed in and withdrawn from a main terminal device, configured to receive a contact command of a user and transmit the received voice command to the main terminal device; and
a main terminal device configured to perform an operation corresponding to the received voice command,
wherein the stylus pen is further configured to:
based on being withdrawn from the main terminal device and receiving a first contact command from the user, activate a microphone in a deactivated state to convert to a main voice input device, and based on receiving a second contact command, transmit application execution control data for executing an application of the main terminal device to the main terminal device, and wherein the main terminal device is further configured to:
execute an application corresponding to the received application execution control data, and
output a command set used in the executed application.

19. The terminal device set of claim 18, wherein the main terminal device is further configured to:
calculate a distance with the stylus pen based on at least one of a data transmission time received from the stylus pen, response time, a time difference between a time at which a same voice of a user is input to the main terminal device and a time at which the same voice of the user is input to the stylus pen, respectively, and
control output based on the calculated distance.

20. The terminal device set of claim 19, wherein the main terminal device is further configured to:
based on the output being an output to display a command set, control a size of display of the command set displayed in accordance with the calculated distance, and
based on the output being an audio output, control a magnitude of the audio volume in accordance with the calculated distance.
